(19) United States
(12) Patent Application Publication
(10) Pub. No.: US 2004/0153688 A1
(43) Pub. Date: Aug. 5, 2004

(54) Abnormality management device for an image forming device, abnormality management system, and program for the same

(75) Inventors: Hirokazu Yamamoto, Osaka (JP); Keiji Okamura, Osaka (JP); Makoto Ochi, Osaka (JP); Yoshiteru Nishikawa, Osaka (JP)

Correspondence Address: SHINJYU GLOBAL IP COUNSELORS, LLP, 1233 20TH STREET, NW, SUITE 700, WASHINGTON, DC, 20036-2680, US

(73) Assignee: KYOCERA MITA CORPORATION, Osaka (JP)

(21) Appl. No.: 10/707,105

(22) Filed: Nov. 20, 2003

(30) Foreign Application Priority Data
Nov. 21, 2002 (JP) 2002-338443

(51) Int. Cl. H04L 1/22

(52) U.S. Cl. 714/1

(57) ABSTRACT

An abnormality management device for an image forming device is disclosed, in which the abnormality management device is connected via a network to an image forming device comprised of a plurality of selectively used paper supply units and/or paper discharge units and which manages abnormalities in the image forming device. The abnormality management device includes a display unit, an abnormality detection unit, and an abnormality display unit. The display unit displays an image of an image forming device on which the plurality of the paper supply units or paper discharge units can be identified. The abnormality detection unit detects abnormalities in the paper supply units or the paper discharge units based upon equipment data acquired from the image forming device. The abnormality display unit displays with emphasis the location of the paper supply unit or paper discharge unit in which an abnormality was detected by the abnormality detection unit on the image of the image forming device.

### BACKGROUND OF INVENTION

1. Field of the Invention

The present invention relates to a management device that manages an image forming device such as a printer, a digital copying machine, a digital multi-function machine, a fax machine, or the like, as well as a system and a program for effectuating the same. More particularly, the present invention relates to a management device that can easily identify abnormalities in paper supply units and/or paper discharge units of an image forming device, as well as a system and a program for effectuating the same.

2. Background Information

Image forming devices having a plurality of paper supply units that supply paper and a plurality of paper discharge units that discharge paper, and which can selectively use the plurality of paper supply units and paper discharge units, are well known in the prior art (see, for example, FIG. 1 and Page 4 of Japanese Published Patent Application No. H07-28362).

This type of image forming device is comprised of a paper size detection function that detects the size of the paper in each paper supply unit, a paper remaining detection function that detects the amount of paper remaining in each paper supply unit and/or the paper in each paper supply unit has been exhausted, and an abnormality detection function that detects abnormalities in each paper supply unit or each paper discharge unit. This type of image forming device is configured so that the detection signals from the aforementioned functions are not only used to properly control the device, but also to display data on the paper size, the amount of paper remaining, and any abnormalities that may have occurred to the user.

In addition, in recent years there has been an increase in image forming devices that are suitable for use on a network. These types of image forming devices not only can be used by a plurality of terminals via a network such as a LAN or the like, but can also be managed (supervised) by means of one or more of these terminals if certain data from the image forming device is provided to the terminal.

This type of management function can be achieved by, for example, installing a management program provided by the image formation device maker in a terminal, thus allowing both the current state of various parameters of the image forming device to be displayed on the terminal screen and the settings of the image forming device to be changed.

FIG. 5 illustrates a conventional example of a management terminal display. As shown in this figure, a conventional management terminal display screen 200 (a display screen showing the current state of the paper supply units) is for example comprised of an image display portion 201 that displays the image forming device as an image, a default selection portion 202 that selects a default paper supply unit from amongst the plurality of paper supply units, a paper size display portion 203 that displays the size of the paper in each paper supply unit, a paper type display portion 204 that displays the type of paper in each paper supply unit, a paper remaining detection display portion 205 that indicates whether or not there is paper remaining in each paper supply unit, and a maximum capacity display portion 206 that displays the maximum number of pages of paper that each paper supply unit can accommodate. The default paper supply unit is clearly indicated on the image display portion 201.

However, in the aforementioned conventional management terminal display 200, when a paper supply unit is determined to be abnormal based upon data acquired from the image forming device, there is a possibility that a text string that indicates the abnormality (e.g., the text string NA in the paper size display unit that indicates that the current paper size for that paper supply unit is unknown) will be obscured by the paper size displays for other paper supply units, and thus a user will overlook the abnormality.

In addition, even if an abnormality in a paper supply unit could somehow be recognized by a user, when the image forming device has a large number of paper supply units, the paper supply unit in which the abnormality occurred cannot be immediately determined by the user because the location of the paper supply unit in which the abnormality occurred cannot be intuitively recognized.

In view of the above, there exists a need for an abnormality management device for an image forming device, abnormality management system, and program for the same which overcomes the above mentioned problems in the prior art. This invention addresses this need in the prior art as well as other needs, which will become apparent to those skilled in the art from this disclosure.

### SUMMARY OF INVENTION

An object of the present invention is to provide a management device, a management system, and a management program for an image forming device that determines if there are abnormalities in a plurality of paper supply units or paper discharge units in an image forming device, displays data on a management terminal display screen that identifies which of the paper supply units and/or paper discharge units have abnormalities, and both reliably identifies the abnormalities in the paper supply units and/or paper discharge units and easily determines the locations of the paper supply units and/or paper discharge units in which the abnormalities occur.

An abnormality management device for an image forming device of the present invention is a device that is connected via a network to an image forming device comprised of a plurality of selectively used paper supply units and/or paper discharge units and which manages abnormalities in the image forming device, the abnormality management device comprised of a display unit, an abnormality detection unit, and an abnormality display unit. The display unit displays an image of an image forming device on which the plurality of the paper supply units or paper discharge units can be identified. The abnormality detection unit detects abnormalities in the paper supply units or the paper discharge units based upon equipment data acquired from the image forming device. The abnormality display unit displays with emphasis the location of the paper supply unit or paper discharge unit in which an abnormality was detected by the abnormality detection unit on the image of the image forming device.

In this device, abnormalities in the paper supply units or paper discharge units can be clearly identified because the location of the paper supply unit or paper discharge unit in which an abnormality was detected is displayed with emphasis on the image of the image forming device. Moreover, even if the image forming device is comprised of a large number of paper supply units or paper discharge units, the location of abnormalities detected in the paper supply units or paper discharge units can be immediately determined because the location of abnormalities detected in the paper supply units or the paper discharge units can be intuitively identified.

In addition, the abnormality management device is preferably further comprised of a default paper supply unit determining unit and a default display unit. The default paper supply unit determining unit determines whether one paper supply unit has been selected as a default. The default display unit displays with emphasis the location of the paper supply unit selected as a default on the image of the image forming device by means of a representation that is different than the representation used to display the paper supply unit in which an abnormality was detected.

Furthermore, the abnormality management device is preferably further comprised of an out of paper determining unit and an out of paper display unit. The out of paper determining unit determines whether any of the plurality of paper supply units have run out of paper based upon equipment data acquired from the image forming device. The out of paper display unit displays with emphasis the location of the paper supply unit which has run out of paper on the image of the image forming device by means of a representation that is different than the representation used to display the paper supply unit in which an abnormality was detected.

In this type of device, not only can the location of the paper display unit in which an abnormality was detected be displayed on the image of the image forming device in the display unit, but the location of the paper supply unit selected as a default and/or the position of the paper supply unit which has run out of paper can be simultaneously displayed as well.

In addition, the abnormality management device is further comprised of a paper size display unit that displays the size of paper stored in each paper supply unit based upon equipment data acquired from the image forming device. The abnormality display unit is preferably configured such that abnormalities are also displayed by means of a symbol or an image in a paper size display position of a paper supply unit in which an abnormality is detected.

Here, even in the paper size display, abnormalities in the paper supply units can be more reliably identified because abnormalities in the paper supply units is clearly displayed. Moreover, by displaying abnormalities with a symbol or an image, not only can the paper size displays of other paper supply units be distinguished therefrom, but the abnormalities can be displayed without the use of words.

In addition, the abnormality management device is further comprised of a paper remaining display unit that displays the amount of paper remaining in each paper supply unit based upon equipment data acquired from the image forming device. The abnormality display unit is preferably configured such that abnormalities are also displayed by means of a symbol or an image in a paper remaining display position of a paper supply unit in which an abnormality is detected by the abnormality detection unit.

Here, even in the paper remaining display, abnormalities in the paper supply units can be more reliably identified because abnormalities in the paper supply units are clearly displayed. Moreover, by displaying abnormalities with a symbol or an image, not only can the paper remaining displays of other paper supply units be distinguished therefrom, but the abnormalities can be displayed without the use of words.

In addition, the abnormality management device is preferably further comprised of a sound abnormality display unit that reports with a sound abnormalities in the paper supply units or the paper discharge units that are detected by the abnormality detection unit. Here, abnormalities in the paper supply unit or the paper discharge unit can be more reliably identified.

An abnormality management system for an image forming device according to the present invention is comprised of an image forming device comprised of a plurality of selectively used paper supply units or paper discharge units, and an abnormality management device that is connected to the image forming device and which manages abnormalities in the image forming device. The abnormality management device is comprised of a display unit, an abnormality detection unit, and an abnormality display unit. The display unit displays an image of an image forming device in which the plurality of the paper supply units or paper discharge units can be identified. The abnormality detection unit detects abnormalities in the paper supply units or the paper discharge units based upon equipment data acquired from the image forming device. The abnormality display unit displays the location of the paper supply unit or paper discharge unit in which an abnormality was detected by the abnormality detection unit on the image of the image forming device.

An abnormality management program for an image forming device of the present invention is a program that is connected via a network to an image forming device comprised of a plurality of selectively used paper supply units and/or paper discharge units, and which serves to effectuate the following functions in a computer which manages abnormalities in the image forming device:

(a) A display function that displays an image of an image forming device in which the plurality of the paper supply units or paper discharge units can be identified;

(b) An abnormality detection function that detects abnormalities in the paper supply units or the paper discharge units based upon equipment data acquired from the image forming device; and

(c) An abnormality display function that displays with emphasis the position of the paper supply unit or paper discharge unit in which an abnormality was detected by the abnormality detection unit on the image of the image forming device.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF DRAWINGS

Referring now to the attached drawings which form a part of this original disclosure:

FIG. 1 is block diagram illustrating a management system for an image forming device;

FIG. 2 is a block diagram illustrating the configuration of the image forming device depicted in FIG. 1;

FIG. 3 is a flowchart illustrating the operation sequence of a management program;

FIG. 4 illustrates a management terminal display screen; and

FIG. 5 illustrates a conventional example of a management terminal display screen.

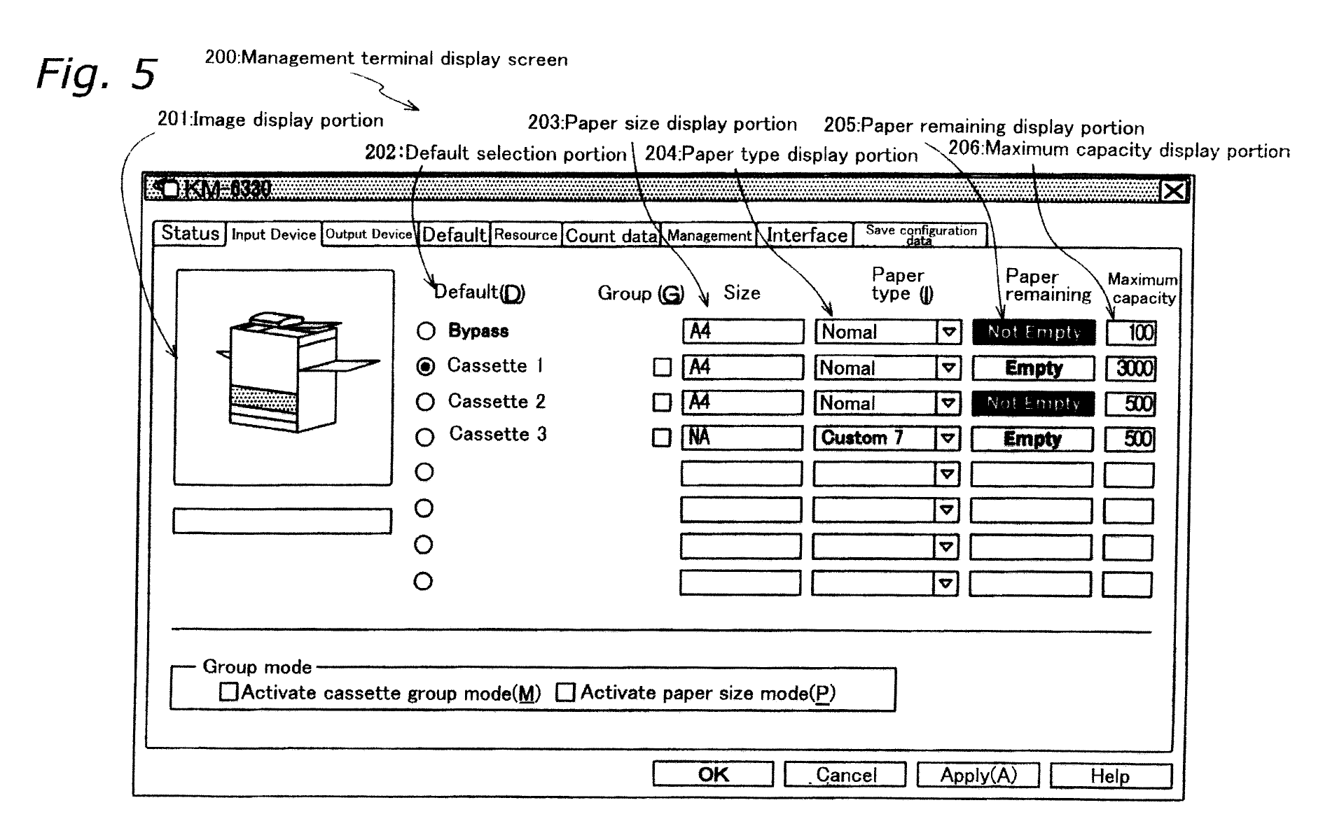

### DETAILED DESCRIPTION

Preferred embodiments of the present invention will be described below with reference to the figures.

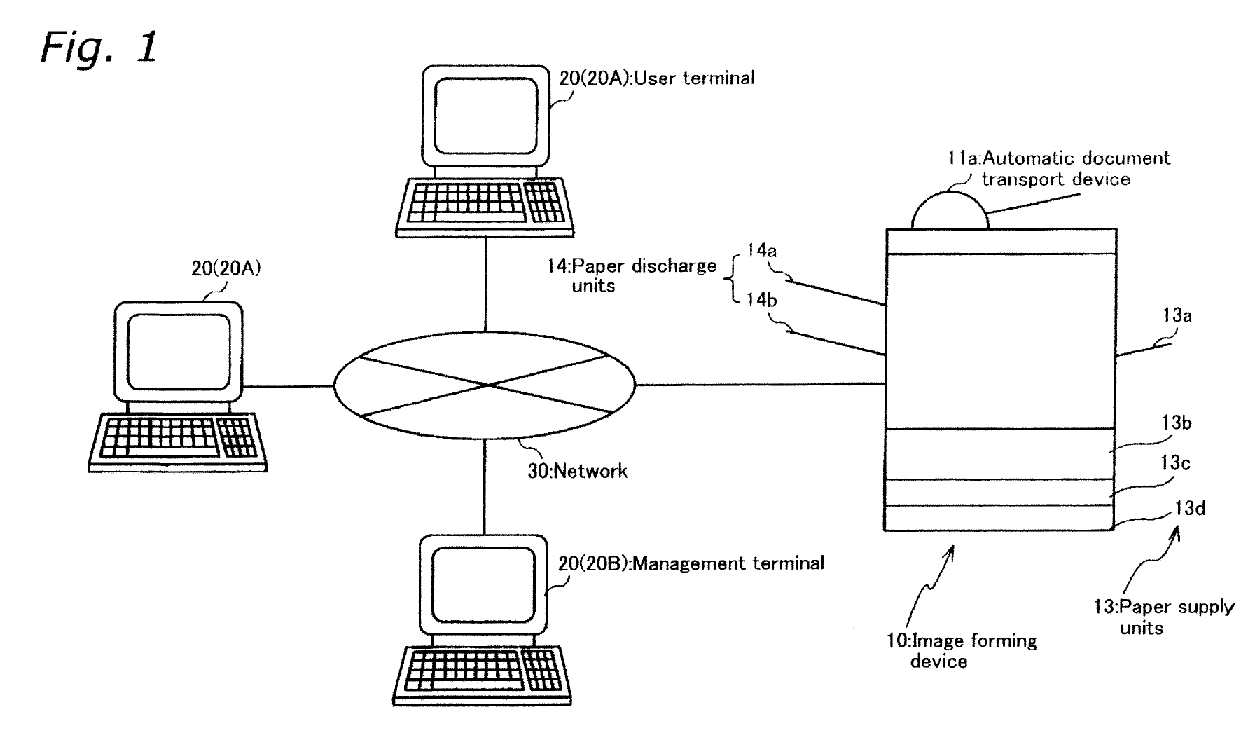

FIG. 1 is a block diagram illustrating a management system for an image forming device. As shown in the figure, a management system for an image forming device is comprised of an image forming device 10, a plurality of terminals 20, and a network 30 such as a LAN or the like that connects the image forming device 10 with the terminals 20.

The image forming device 10 may be a printer, a digital copying machine, a digital multi-function device, a facsimile device, or the like. However, in the present embodiment the image forming device 10 is a digital multi-function device in which the functions of a copying machine, a printer, and a scanner are combined into one device.

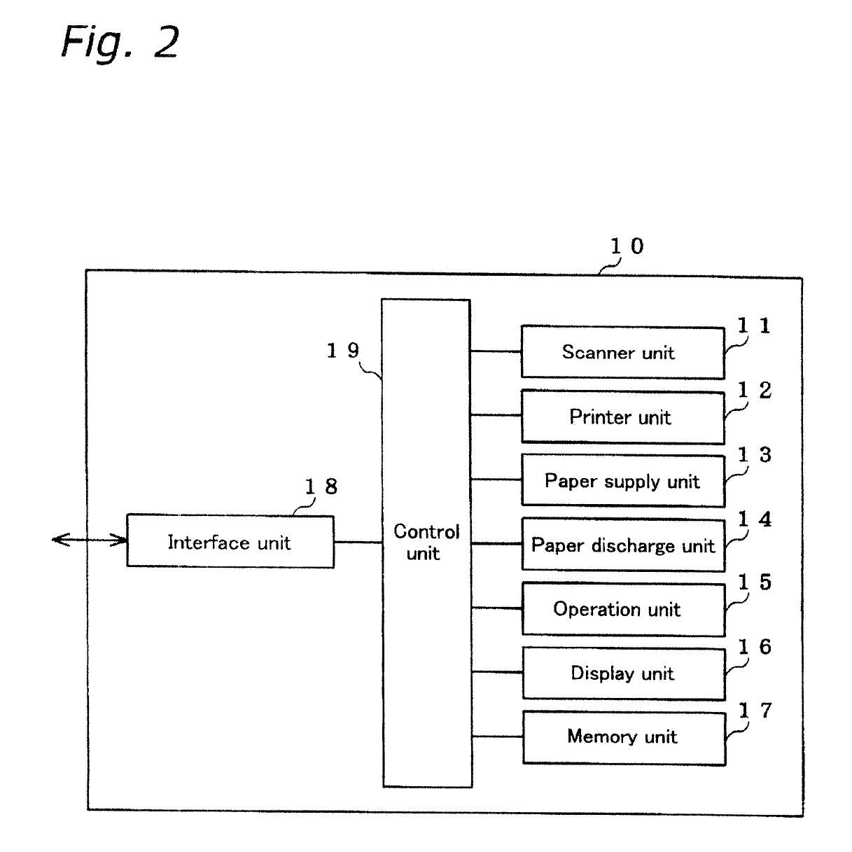

FIG. 2 is a block diagram illustrating the configuration of the image forming device 10. As shown in the figure, the image forming device 10 is comprised of a scanner unit 11, a printer unit 12, a paper supply unit 13, a paper discharge unit 14, an operation unit 15, a display unit 16, a memory unit 17, an interface unit 18, and a control unit 19.

The scanner unit 11 reads original documents placed on a document platen at a predetermined resolution, and is equipped with an automatic document transport device 11a that sequentially transports a plurality of original documents to the document platen.

The printer unit 12 prints image data read by the scanner unit 11 and/or character data transmitted from the terminals 20.

The paper supply unit 13 supplies paper to the printer unit 12. The paper supply unit 13 of the image forming device 10 is comprised of a bypass paper supply unit 13a that allows paper having an arbitrary size to be used in the image forming device 10, and a plurality of cassette paper supply units 13a-13d (cassettes 1 to 3) in which paper having predetermined sizes are placed therein. Any of the paper supply units 13a-13d can be selectively used by the image forming device 10. Each paper supply unit 13a-13d is comprised of a paper size detection function that detects the size of the paper placed in the paper supply unit, a paper remaining detection function that detects whether or not there is paper remaining in the paper supply unit, and an abnormality detection function that detects abnormalities such as paper jams, an improperly mounted cassette, or the like. The detection signals from each detection function are input into the control unit 19.

The paper discharge unit 14 discharges documents that have been printed by the printer unit 12. The paper discharge unit 14 of the image forming device 10 is comprised of a plurality of paper discharge units 14a, 14b, and the paper discharge units 14a, 14b are selected in response to the size of the paper to be discharged and/or the presence or absence of post-processing (stapling, hole punching, or the like). Each paper discharge unit 14a, 14b is comprised of an abnormality detection function that detects abnormalities such as paper jams and the like, and the detection signals therefrom are input into the control unit 19.

The operation unit 15 carries out the various operations of the image forming device 10, and operations such as function selection, paper selection, page number setting, magnification setting, density setting, operation initiation, and the like are carried out thereby by means of a plurality of key operations.

The display unit 16 displays the operational state and the current settings of the image forming device 10, and is comprised of a display device such as a liquid crystal panel or the like.

The memory unit 17 temporarily stores copy data, stores scanner data, buffers printer data, and stores equipment data (described below), and is comprised of, for example, a hard disk.

The interface unit 18 connects the control unit 19 to the network 30, and is comprised of, for example, a LAN interface that conforms with the 10BASE-T/100BASE-TX protocols.

The control unit 19 controls each unit of the image forming device 10, and sends and receives print data, scan data, equipment data, and the like to and from the terminals 20. The equipment data is data in a predetermined format (for example, MIB) that describes the operational state and setting state of the image forming device 10, and includes paper size detection data from each paper supply unit 13a-13d, data on the amount of paper remaining in each paper supply unit 13a-13d, data on the detection of any abnormalities in each paper supply unit 13a-13d, data on the detection of any abnormalities in each paper discharge unit 14a, 14b, and the like. A predetermined management protocol is used to send and receive the equipment data. The management protocol specifies the format of queries from the terminals 20 to the network equipment (image forming device 10) as well as the format of responses from the network equipment to the terminals 20. For example, a TCP/IP type of management protocol such as SNMP may be used.

The terminals 20 are comprised of computers such as personal computers or the like that can connect to the network 30, and include user terminals 20A that allows one to use the image forming device 10 and a management terminal 20B that allows one to manage the image forming device 10. A predetermined printer driver and scanner driver are installed in the user terminals 20A, and allow one to use the image forming device 10. In addition, by installing a predetermined management program in the management terminal 20B, the management terminal 20B can display the current state of the image forming device 10 and change the settings of the image forming device 10.

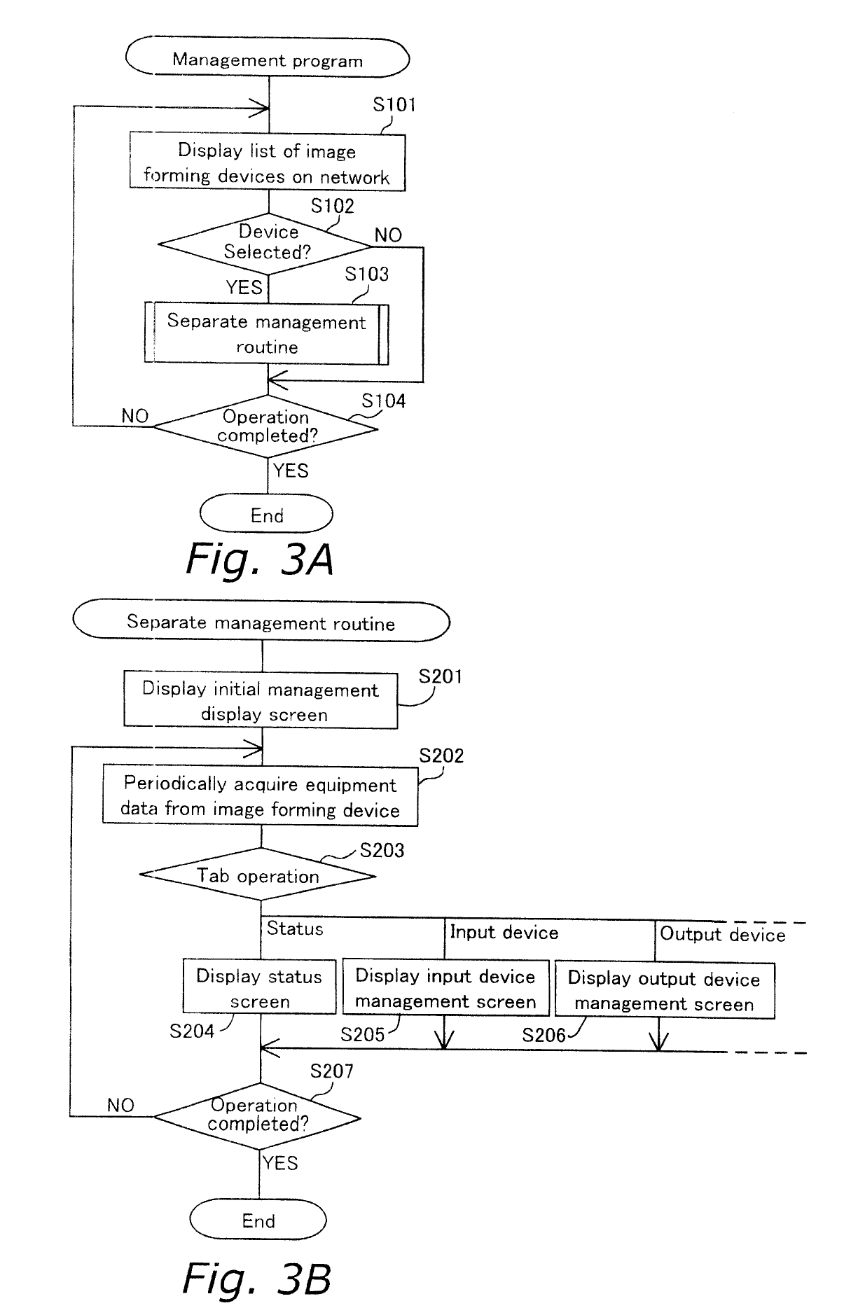

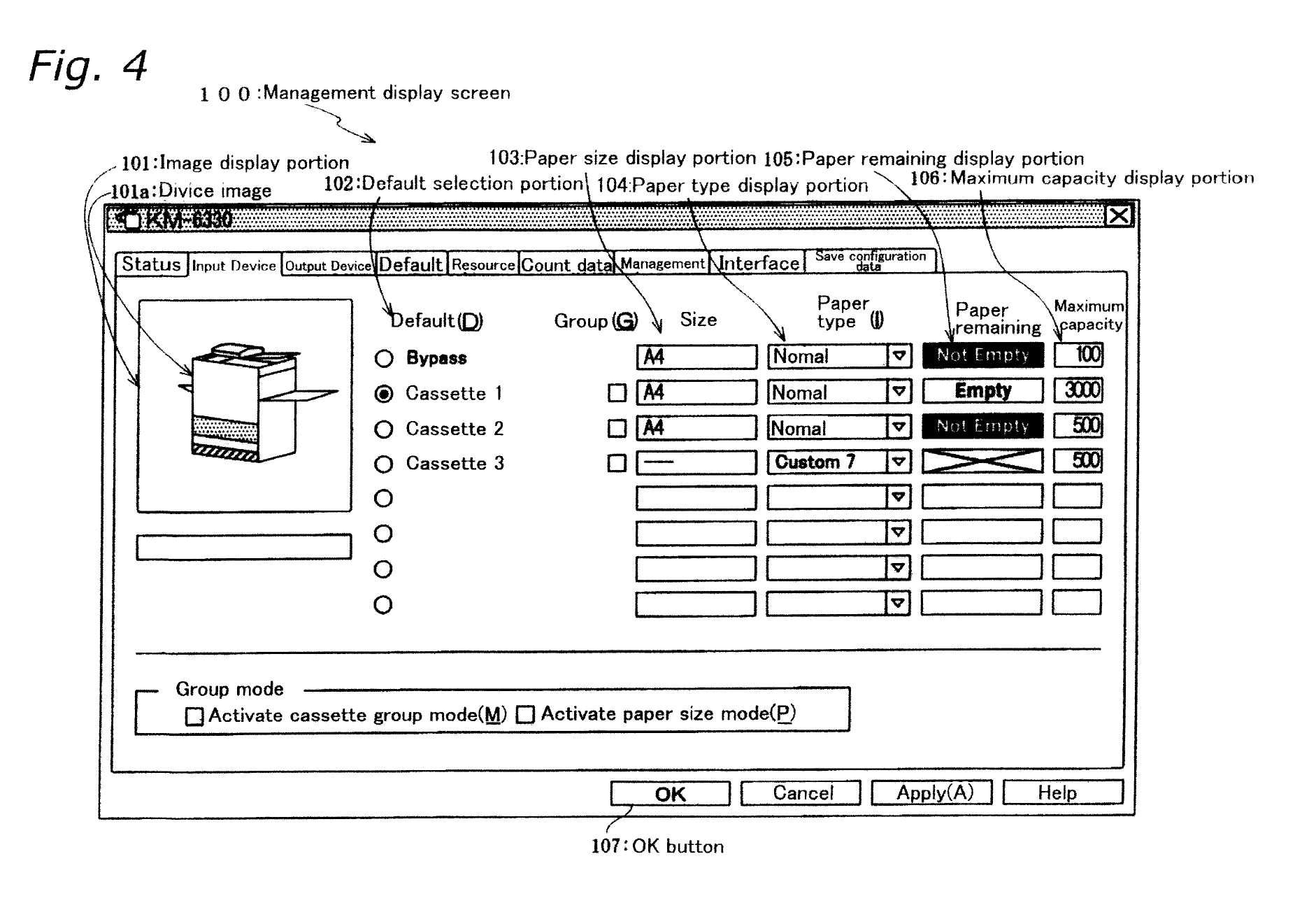

FIG. 3 is a flowchart that illustrates the operational sequence of the management program, and FIG. 4 illustrates a screen of the management terminal.

As shown in FIG. 3, when the management program is executed on the management terminal 20B, the program searches for image forming devices 10 on the network 30, and displays a list screen of the image forming devices 10 found thereon (Step S101). If an image forming device 10 is selected from this list screen (not shown in the figures) (Step S102), then a separate management routine is executed (S103) and the management display screen 100 shown in FIG. 4 is created. In addition, if the user indicates that he or she has completed the selection operation (Step S104), the list screen closes and the process will be completed.

The separate management routine displays the management display screen 100 in its initial state (Step S201), contacts the image forming device 10, and then periodically acquires equipment data therefrom (Step S202). The management display screen 100 includes a status screen that displays the current state of the image forming device 10 (Step S204), an input device management screen that displays the current state of the paper supply units 13a-13d and the default settings (Step S205), an output device management screen that displays the current state of the paper discharge units 14a, 14b (Step S206), and the like. A user can switch between these screens by, for example, selecting the desired tabs shown at the top of the management display screen 100 in FIG. 4. In addition, if the user indicates that he or she has is completed viewing of these screens (Step S207), the management screen closes and the process will be completed.

As shown in FIG. 4, the input device management display screen 100 is comprised of an image display portion 101, a default selection portion 102, a paper size display portion 103, a paper type display portion 104, a paper remaining display portion 105, a maximum capacity display portion 106, and the like, and the contents of this display can be updated in accordance with equipment data acquired from the image forming device 10.

The image display portion 101 displays the image formation device 10 as an image, and a device image 101a displayed here is automatically updated in accordance with the type of image forming device 10 and the configuration of the options.

The device image 101a employs colors, designs, flashing lights, and the like to represent the locations of each paper supply unit 13a-13d and emphasize the display thereof. When an abnormality in the paper supply units 13a-13d has been identified, this emphasized display is executed at the location in the device image 101a in which the abnormality is located based upon equipment data acquired from the image forming device 10. Thus, not only can abnormalities in the paper supply units 13a-13d be reliably identified, but the location of the abnormality in the paper supply unit 13a-13d can be easily determined.

In addition, in the present embodiment, both the location of the paper supply unit 13a-13d selected as a default and the locations of the paper supply units 13a-13d which have run out of paper are emphasized in the device image 101a. When this occurs, each of these two states can be identified by employing representations that are different than that used with an abnormal paper supply unit 13a-13d (e.g., different colors), even if an abnormal display, a default display, and a “no paper” display occur simultaneously.

The default selection portion 102 selects the paper supply unit 13a-13d to be used as a default from amongst the paper supply units 13a-13d. After one of the paper supply units 13a-13d is selected, that paper supply unit is set as the default by clicking an “OK” button 107. However, it will not be possible to select a paper supply unit 13a-13d in which an abnormality has been detected.

The paper size display portion 103 displays the size of the paper in each paper supply unit 13a-13d, based upon equipment data acquired from the image forming device 10. Normally, in the paper size display portion 103, paper sizes such as “A4”, “B4”, and the like are displayed with text characters, however an abnormality is displayed by means of a symbol or image in the paper size display location of the paper supply units 13a-13d in which an abnormality was detected. For example, in the paper size display position, if a symbol “- - -” or the like is displayed, the other paper size displays will not be obscured, and the abnormal paper supply unit 13a-13d can be clearly shown. Thus, not only can an abnormal paper supply unit 13a-13d be clearly identified, but the abnormality can be displayed without the use of written words.

The paper type display portion 104 displays the type of paper in each paper supply unit 13a-13d. The paper types that can be set in the management display screen 100 shown in FIG. 4 are limited, however a type of paper not listed in the management display screen 100 can be set if a predetermined decontrol operation is performed.

The paper remaining display portion 105 indicates whether or not there is any paper remaining in each paper supply unit 13a-13d based upon equipment data acquired from the image forming device 10. Normally, the paper remaining display 105 will display text such as “Empty” or “Not Empty” to indicate whether or not there is paper remaining in the paper supply units 13a-13d. However, a symbol or image will be displayed in the paper remaining display 105 at the location of the paper supply unit 13a-13d in which an abnormality was detected. For example, in the paper remaining display position, if an image such as an “X” or the like is displayed in red, the other paper size displays will not be obscured, and the abnormal paper supply unit 13a-13d can be clearly shown.

Note that although not shown in the figures, an image display portion is also provided in the output management display screen included in the management display screen 100. The device image displayed here employs colors, designs, flashing lights, and the like to emphasize the positions of each paper discharge unit 14a, 14b. When abnormalities in the paper discharge units 14a, 14b have been identified, this emphasized display is executed at the position in which the abnormality is located based upon equipment data acquired from the image forming device 10. Thus, not only can abnormalities in the paper discharge units 14a, 14b be reliably identified, but the location of an abnormality in the paper discharge units 14a, 14b can be easily recognized.

In addition, in the present embodiment, when an abnormality is identified in the paper supply units 13a-13d and/or the paper discharge unit 14a, 14b, a sound will be generated based upon equipment data acquired from the image forming device 10 that notifies the user of an abnormality in the paper supply unit 13a-13d and/or the paper discharge unit 14a, 14b. For example, an abnormality in the paper supply units 13a-13d and/or the paper discharge unit 14a, 14b can be made more clearly recognizable by outputting a sound such as A problem has occurred in paper supply cassette 1 on the management terminal 20B.

According to the management system for the image forming device 10 described above, abnormalities in the paper supply units 13a-13d and/or the paper discharge unit 14a, 14b can be clearly identified because the location of the abnormalities in the paper supply units 13a-13d and/or the paper discharge units 14a, 14b will be displayed with emphasis in the device images displayed on the management display screen 100. Moreover, because the location of abnormalities in the paper supply units 13a-13d and/or the paper discharge units 14a, 14b can be intuitively identified, the location of the abnormalities in the paper supply unit 13a-13d and/or paper discharge units 14a, 14b can be immediately determined even if the image forming device 10 includes a large number of paper supply units 13a-13d and/or paper discharge units 14a, 14b.

In addition, in the input device management display screen 100, the representation employed to indicate the location of the paper supply unit 13a-13d selected as a default and/or the location of the paper supply unit 13a-13d that has run out of paper will be different than that used to indicate a paper supply unit 13a-13d in which an abnormality has been detected, and this representation will be displayed with emphasis in the device image 101a. Thus, not only can the default paper supply unit and/or a paper supply unit that has run out of paper be clearly identified, but the locations thereof can be easily determined.

Furthermore, in the paper size display portion 103 and/or the paper remaining display portion 105 of the input device management display screen 100, because an abnormality is displayed by means of a symbol or an image in the paper size display position and/or the paper remaining display position of the paper supply unit 13a-13d in which an abnormality has been detected, not only can abnormalities in the paper supply units 13a-13d be more clearly identified, but the abnormality can be displayed without the use of words.

Note that the present invention is not limited to the aforementioned embodiment. For example, in the aforementioned embodiment, the image forming device 10 is connected with the terminals 20 via a LAN. However, the image forming device 10 may be connected with the terminals 20 via a Centronics parallel connector or the like or a serial connector such as a USB or the like.

In addition, in the aforementioned embodiment, a management program is used to manage the image forming device 10. However, the management program may be replaced with a printer driver that incorporates the functions of the management program therein.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing description of the embodiments according to the present invention are provided for illustration only, and not for the purpose of limiting the invention as defined by the appended claims and their equivalents.

1. An abnormality management device connected via a network to an image forming device that includes a plurality of selectively used paper supply units or paper discharge units, the abnormality management device managing abnormalities in the image forming device and comprising:
a display unit that displays an image of an image forming device in which the plurality of the paper supply units or paper discharge units can be visually distinguished from each other;
an abnormality detection unit that detects abnormalities in the paper supply units or the paper discharge units based upon equipment data acquired from the image forming device; and
an abnormality display unit that displays with emphasis the location of the paper supply unit or paper discharge unit in which an abnormality was detected by the abnormality detection unit on the image of the image forming device.

2. The abnormality management device set forth in claim 1, further comprising:
a default paper supply unit determining unit that determines whether one paper supply unit from amongst the plurality of the paper display units has been selected as a default; and
a default display unit that displays with emphasis the position of the paper supply unit selected as a default on the image of the image forming device by means of a representation that is different than a representation used to display the paper supply unit in which an abnormality was detected.

3. The abnormality management device set forth in claim 1, further comprising:
an out of paper determining unit that determines based upon equipment data acquired from the image forming device whether any of the plurality of paper supply units have run out of paper; and
an out of paper display unit that displays with emphasis the position of a paper supply unit that has run out of paper on the image of the image forming device by means of a representation that is different than a representation used to display the paper supply unit in which an abnormality was detected.

4. The abnormality management device set forth in claim 1, further comprising a paper size display unit that displays based upon equipment data acquired from the image forming device the size of paper stored in each paper supply unit;
wherein the abnormality display unit displays an abnormality by means of a symbol or an image in a paper size display location of a paper supply unit in which an abnormality has been detected by means of the abnormality detection unit.

5. The abnormality management device set forth in claim 1, further comprising a paper remaining display unit that displays based upon equipment data acquired from the image forming device the amount of paper remaining in each paper supply unit;
wherein the abnormality display unit displays an abnormality by means of a symbol or an image in a paper remaining display location of a paper supply unit in which an abnormality has been detected by means of the abnormality detection unit.

6. The abnormality management device set forth in claim 1, further comprising a sound abnormality generating unit that generates a sound when an abnormality is detected in a paper supply unit or a paper discharge unit by the abnormality detection unit.

7. An abnormality management system for an image forming device, comprising:
an image forming device comprising a plurality of selectively used paper supply units or paper discharge units; and
an abnormality management device connected to the image forming device which manages abnormalities in the image forming device, the abnormality management device comprising:
a display unit that displays an image of an image forming device in which the plurality of the paper supply units or paper discharge units can be visually distinguished from each other;
an abnormality detection unit that detects abnormalities in the paper supply units or the paper discharge units based upon equipment data acquired from the image forming device; and
an abnormality display unit that displays with emphasis the location of the paper supply unit or paper discharge unit in which an abnormality was detected by the abnormality detection unit on the image of the image forming device.

8. The abnormality management system set forth in claim 7, further comprising:
a default paper supply unit determining unit that determines whether one paper supply unit from amongst the plurality of the paper display units has been selected as a default; and
a default display unit that displays with emphasis the position of the paper supply unit selected as a default on the image of the image forming device by means of a representation that is different than a representation used to display the paper supply unit in which an abnormality was detected.

9. The abnormality management system set forth in claim 7, further comprising:
an out of paper determining unit that determines based upon equipment data acquired from the image forming device whether any of the plurality of paper supply units have run out of paper; and
an out of paper display unit that displays with emphasis the position of a paper supply unit that has run out of paper on the image of the image forming device by means of a representation that is different than a representation used to display the paper supply unit in which an abnormality was detected.

10. The abnormality management system set forth in claim 7, further comprising a paper size display unit that displays based upon equipment data acquired from the image forming device the size of paper stored in each paper supply unit;
wherein the abnormality display unit displays an abnormality by means of a symbol or an image in a paper size display location of a paper supply unit in which an abnormality has been detected by means of the abnormality detection unit.

11. The abnormality management system set forth in claim 7, further comprising a paper remaining display unit that displays based upon equipment data acquired from the image forming device the amount of paper remaining in each paper supply unit;
wherein the abnormality display unit displays an abnormality by means of a symbol or an image in a paper remaining display location of a paper supply unit in which an abnormality has been detected by means of the abnormality detection unit.

12. The abnormality management system of the image forming device disclosed in claim 7, further comprising a sound abnormality generating unit that generates a sound when an abnormality is detected in a paper supply unit or a paper discharge unit by the abnormality detection unit.

13. An abnormality management program that is executed in a computer that is connected via a network to an image forming device that includes a plurality of selectively used paper supply units or paper discharge units, the abnormality management program managing abnormalities in the image forming device and comprising:
a display function that displays an image of an image forming device in which the plurality of the paper supply units or paper discharge units can be visually distinguished from each other;
an abnormality detection function that detects abnormalities in the paper supply units or the paper discharge units based upon equipment data acquired from the image forming device; and
an abnormality display function that displays with emphasis the location of the paper supply unit or paper discharge unit in which an abnormality was detected by the abnormality detection unit on the image of the image forming device.
